(19) United States
(12) Patent Application Publication
(10) Pub. No.: US 2007/0021973 A1
(43) Pub. Date: Jan. 25, 2007

(54) Automated community to exchange philanthropy information

(75) Inventor: Troy Stremler, Englewood, CO (US)

Correspondence Address: KLARQUIST SPARKMAN, LLP, 121 SW SALMON STREET, SUITE 1600, PORTLAND, OR, 97204, US

(73) Assignee: NewDea, Inc.

(21) Appl. No.: 11/493,502

(22) Filed: Jul. 25, 2006

Related U.S. Application Data
(60) Provisional application No. 60/702,442, filed on Jul. 25, 2005.

(51) Int. Cl. G06Q 99/00

(52) U.S. Cl. 705/1

(57) ABSTRACT

A plurality of users, which may comprise donors, charitable organizations, beneficiaries, businesses, advertisers, etc. can be allowed to access an online communication system designed around one or more philanthropical endeavors. The online communications system can include a chat room, a blog, an online forum, an email mailing list, etc, as well as a community goal, a community calendar, and links to projects that users may wish to donate to. Advertising may be included, the advertising displaying specific ads for specific users, the choice of ad depending on information known about the user by the online communications system. The online communications system can require registration before allowing entry.

### CROSS REFERENCE TO RELATED APPLICATIONS

This application claims the benefit of U.S. Provisional Application No. 60/702,442, filed Jul. 25, 2005. This application is incorporated herein in its entirety. This application hereby expressly incorporates by reference, the common applicant's prior U.S. patent application Ser. No. 10/290,556, filed Nov. 8, 2002, entitled PHILANTHROPY MANAGEMENT SYSTEM AND METHODS OF USE AND DOING BUSINESS. This applicationzxpressly incorporates by reference, the common application's prior U.S. patent application Ser. No. 10/873,995, filed Jun. 21, 2004, entitled PHILANTHROPY MANAGEMENT SYSTEM AND METHODS OF USE AND DOING BUSINESS.

### FIELD OF THE INVENTION

Systems and methods described herein relate to providing automated access to an automated community of persons having an interest or involvement in philanthropic activity, issues, or concerns.

### COPYRIGHT AUTHORIZATION

A portion of the disclosure of this patent document contains material which is subject to copyright protection. The copyright owner has no objection to the facsimile reproduction by anyone of the patent disclosure, as it appears in the Patent and Trademark Office patent file or records, but otherwise reserves all copyright rights whatsoever.

### BACKGROUND

Philanthropy has been essential to advancement of society and betterment of the human condition for hundreds of years. Many of the very finest educational, health care, and religious institutions and activities have long been the direct result of philanthropic donations and activities. The resulting institutions, services, and products not only often fulfill substantial voids that have not been, and often cannot be, met by government, but also expand the range of options and competitive alternatives to institutions, services, and products provided by the government or other private activities and entities. The net result of the interplay between philanthropic institutions, government, and private institutions is not only a more efficient allocation of resources in the market and society as a whole, but also a substantial increase in the quality of societal morals, education, human interaction, spiritual accomplishment, and life all across society.

The effort involved, however, in actually making and managing donations on behalf of philanthropists or philanthropic institutions owning or controlling the capital is often a sizable, costly, and time consuming challenge, particularly for those individuals or entities seeking to engage in philanthropic activities without use of a foundation. In general, identifying and researching charitable organizations can be difficult. More particularly, it is difficult to track and discuss how and where donations are being used. To help solve these problems, the applicants have developed automated systems and methods for philanthropists to gain access to projects and organizations of interest and, if desired, for projects and organizations to gain access to philanthropists or philanthropic or other funding. Implementations of such donation management systems and methods are described in common applicant's prior U.S. patent application Ser. No. 10/873,995, entitled “Philanthropy Management System and Methods of Use and Doing Business” and U.S. patent application Ser. No. 10/290,556, entitled “Philanthropy Donation Management Apparatus, System, and Methods of Use and Doing Business,” which have been incorporated herein by reference.

These systems make a variety of tools remotely accessible to donors, philanthropic organizations, project managers, team members, and others, which allow such entities to gain access to the systems from disparate locations, such as through an intranet or the Internet. The systems provide tools for organizations to manage information about themselves and projects with which they are connected or in which they are interested. They also provide tools for donor users to manage information about themselves and entities in which they have donated or that they are monitoring, and tools to find and associate themselves with those and other entities.

Despite the numerous tools and features described in the prior systems, they generally have not provided a centralized online community meeting place. Thus, prior systems have not provided a site or place for donor users to meet, chat, and openly procure and exchange information with other donors.

Similarly, prior systems have not provided a centralized meeting place for those with interest in a charity or a charitable project to meet and discuss charitable work who are not themselves donors, such as those who work for charitable organizations, potential donors, and those who will benefit from the philanthropic aid.

Such systems also have not provided secure communications, such as private blogs, mailing lists, invitation only chat rooms, online forums and the like, with varying levels of access, which could be used to facilitate a free exchange of information with others with similar charitable interests.

Furthermore, prior systems have not provided a way for advertisers or other businesses to easily advertise, for example, their commitment to shared goals to persons in a community type of facility. Such systems have also not provided a central location for such businesses to easily advertise their participation in charitable projects of interest to such a captive audience.

Moreover, as there is no shared meeting place, it is difficult for businesses interesting in tailoring marketing to those with charitable interests to gather material specific enough about individual donors to provide effective tailored communication. Additionally, even if such material could be gathered, it is currently difficult to present the information in an appropriate setting.

Prior art systems also have not provided a vehicle of providing charitable or other project assessment, management, or funding along with a community communications or information sharing facility.

### SUMMARY

The present application relates to providing automated access to an automated community of persons having an interest or involvement in philanthropic activity, issues, or concerns. Certain embodiments facilitate communication among the charitable community by providing a philanthropical meeting place. One implementation has an online meeting place where like-minded individuals can gather. The online meeting place can be associated with t with a charitable organization. In another implementation, the online meeting place is associated with a donor management system that may itself be associated with several charitable organizations.

Accordingly, certain embodiments can provide a convenient place or site for people who otherwise might have difficulty meeting face-to-face, such as those who live far apart, those with busy schedules, etc, to become members of an online community interested in philanthropic endeavors to meet and discuss issues of interest.

Users of such an online meeting place may include donors, potential donors, charitable institutions and their members, members of the media, beneficiaries, potential beneficiaries, businesses, advertisers to the online community, potential advertisers, and so forth.

In certain embodiments, the online meeting place may have one or more online communications accessible to users. Such online communications may be both synchronous and asynchronous to allow users to use the types of communication they are most comfortable with. For example, synchronous communications, such as chat rooms, let users talk to others in real time which may allow those who would not otherwise meet to get to know each other quite well. Synchronous communications that may be available include chat rooms and text messaging. Asynchronous communications allow users to compose messages with care, which they can then broadcast when they wish. Users can also read such communications whenever they like, rather than speaking to others only when both parties are online simultaneously. Asynchronous communications which may be available include online forums, blogs, email lists, podcasts (or web broadcasts), and the like. Such types of communications bolster the sense that the people involved belong to a community.

Certain embodiments of the online meeting place provide for tiered levels of access, such that members of the online community can speak frankly among themselves. To facilitate access restrictions, or for other reasons, the online communications system can require registration before allowing entry, and a given user can be given full access, partial access, or no access to any given portion of the online communication system. In some embodiments, access can be related to allowing or disallowing certain people or groups of people from reading or writing to specified forms of online communications, such as disallowing beneficiaries of aid from a certain project to read or write to blogs, chat rooms, or online message boards which concern projects other than their own. Similarly, there may be chat rooms that only donors are allowed to enter, freeing them from worry that charitable organization administrators, beneficiaries, or others, may be eavesdropping. Certain embodiments do not require registration.

In a feature that can be included in certain embodiments, a profile is requested prior to allowing a user access to the online meeting place. This profile may ask for general information such as age, date of birth, address, and such. The profile also might ask for much more specific information such as favorite charities, short- and long-term charitable goals, past donations, and the like. The profile may also allow a user to set up one or more aliases, allowing the user to interact, and even donate, anonymously.

In another feature that can be included in certain embodiments, a database is provided, which is at least partially accessible within the online meeting place. The database may store information, such as online communications by certain members, information about charities, information about beneficiaries, and/or information about donors.

Links can be provided, in certain embodiments, which allow a user to donate to a charitable cause directly from the online meeting place. In another feature which can be included in some embodiments, users may be able to retrieve, using a search function, a lookup function, or by using direct links, information about areas of interest such as specific charities, specific projects being run by a given charity, and other information about the charity. In some embodiments, a specific community meeting place may limit the scope of the search function, such that only charities, projects, etc. sponsored, approved, etc, by the community meeting place can be accessed at the community meeting place. In certain embodiments, this can heighten the community feeling, as the virtual space can be devoted to a specific cause, which can have the effect of ensuring that the people participating in the community are there for the stated goals.

In another embodiment, an online community meeting place has a community goal, such as an amount of money, in-kind contributions, or volunteer hours to raise for a specific philanthropic project. The community meeting place may also be able to donate to an organization which may be associated with its goal in the name of the community meeting place itself, rather than under the names of the individual members. A link or links to information about projects of interest may also be included. Another feature, which may be included in certain embodiments, is a community calendar. The calendar may allow members to plan get-togethers, either on-line or in the real world. Such personal time spent together can further cement the notion of belonging to a community of like-minded individuals among the online community members. Certain members of an online community associated with the online community meeting place may be given access to modify the calendar. In another embodiment, no special access is necessary to modify the calendar.

This allows for a user to enter the community meeting place, read about various charities using the online database, determine which projects may be of interest, and then, using the chat rooms, online forums, and the like, discuss the projects of interest with people who may be benefiting from the charity, people who may be administering the charity, people who are already donating, and the like. When the user finds a suitable project, he or she may donate to the charity, charitable project, etc. of their choice, using the link function present within the online community meeting place.

In some embodiments, the community meeting place may be personalizable. That is, the look of a web page presented to a user of the community meeting place may have a few, some, or any aspect, changed. For example, a logo of a donor sponsoring a community meeting place may be displayed, the Graphical User Interface features, such as buttons, drop-down lists, and links, can be customized, and/or features, such as online-communication features (blogs, chat rooms, online forums, etc.) may be able to be added or subtracted. This adds to the community feeling.

In certain embodiments, businesses may present advertisements to a user at various times when in the online community meeting place, or at other times, such as in emails directed to a given user or grouping of users. Advertisements may appear when a user enters the online community meeting place; advertisements may be associated with a chat room, online message boards, the community calendar, etc. Furthermore, the advertising may be specifically tailored for a specific user, or grouping of users using information about the user(s) gleaned from registration information provided by the user as well as other information known about the user from other sources, such as donation history, and information given in online communications. Advertisers may also choose to advertise their commitment to charitable goals, such as, for example, by matching user contribution dollars to a project or projects.

In another embodiment, the online community meeting place comprises a communication module, which allows members of the online community can exchange information about a philanthropic cause. As a feature present in some instances of the embodiment, the communication module may include at least one of: a chat room, a blog, an online forum, or an email mailing list. An advertising module may be included in some embodiments. In those embodiments with an advertising module, .the advertising may be for at least one of: a project, a charitable organization, a for-profit business, or a donor management system associated with the online community meeting place.

As another feature of certain embodiments, an advertising associator, may be included. The advertising associator associates a member of the online community with a specific advertisement based upon information that the associator gleans from available sources, such as a database associated with the online community, registration information such as a profile generated during registration, and so forth. An advertising displayer may also be a feature of one or more embodiments. Such an advertising displayer would display the advertisement associated with a member of the online community when the member of the online community is in the online community meeting place.

A moderator module may also be included. Such a moderator module enables a moderator can be used to determine a level of access for a user of the centralized meeting place. At least one embodiment includes a user registration module which can generate a user registration profile which may then be used to allow a user to gain access to the online community meeting place.

In a further embodiment, a method for providing a philanthropic community communication system is provided. In this system, an online philanthropic community system is provided. Also, within the online philanthropic community communication system a first plurality of online users can be allowed to conduct a first topic on-line communication among each other. Also, one or more additional online users can be allowed to have access to said first topic on-line communication. These additional online users can also be allowed to participate in the first topic on-line communication. Furthermore, he first plurality of online users, or another plurality of online users can be allowed to conduct a second topic on-line communication among each other. One or more additional online users may also be allowed to have access to the second topic on-line communication. They may also be allowed to participate in the second topic on-line communication. Further, the online communication may comprises at least one of chatting, blogging, or engaging in an online bulletin board discussion.

In yet another embodiment, a method of providing a philanthropic community communication system in conjunction with a philanthropic project information system is provided. It includes providing an online philanthropic project information system; posting information regarding philanthropic projects; with the online philanthropic project information system, allowing online users to access the philanthropic information system. These users may also be allowed to review the information regarding philanthropic projects. Furthermore, an online philanthropic community communication system may be provided in conjunction with the philanthropic project information system. A first plurality of online users may be allowed to conduct on-line communication among each other. One or more additional online users may also be allowed to have access to the on-line communication ,and to participate in said on-line communication. The online communication to may include at least one of chatting, blogging, or engaging in an online bulletin board discussion.

The foregoing Summary recites various features and advantages of various embodiments of the invention. It is to be understood that all embodiments need not necessarily include all such features or provide all such advantages or address the issues noted in the background. It is also to be understood that there are additional features and advantages of certain embodiments, and they will become apparent as the specification proceeds.

### BRIEF DESCRIPTION OF THE DRAWINGS

The preferred and other embodiments are shown in the accompanying drawings in which:

FIG. 1A is a block diagram of an exemplary system for allowing donors, charitable organizations and others to communicate within a community meeting place that can be used to implement an automated community to exchange philanthropic information;

FIG. 1B is a block diagram which extends the philanthropic community meeting place system shown in FIG. 1A by showing aspects of a donor management system which can be used to implement the philanthropic community meeting place of FIG. 1A;

FIG. 2 is an expanded view of the donor management system shown in FIG. 1B which integrates the community meeting places of FIG. 1A;

FIG. 3 is a block diagram of online communication embodiments that can be used by a philanthropic meeting place to provide communication between entities such as between the donors and the donor management system of FIG. 1B;

FIG. 4 is a block diagram of an exemplary system comprising a client-server system for enabling online communications such as those shown in FIG. 3;

FIG. 5 is a block diagram of exemplary chat features that further expands the chat feature shown in FIG. 3;

FIG. 6 is a block diagram of an exemplary community meeting place database configuration that extends the database diagram shown in FIG. 1B;

FIG. 7A is a flowchart showing an exemplary method for allowing access to the community meeting place which extends the attempt access method shown in FIG. 2;

FIG. 7B is a flowchart showing an exemplary method for determining the level of access will be allowed, which extends the level of access method shown in FIG. 7A;

FIG. 8 is a flowchart showing an exemplary method for registering at the community meeting place which extends the determine level of access method as shown in FIG. 7A;

FIG. 9 is a block diagram of another exemplary community meeting place embodiment, such as the philanthropic community meeting place shown in FIG. 1A;

FIG. 10 is a block diagram of an exemplary marketing system which extends the community meeting place marketing system as shown in FIG. 9;

FIG. 11 is a flowchart showing an exemplary method for accessing an online community such as the attempt access method shown in FIG. 2;

FIG. 12 is a block diagram of another embodiment of the database shown in FIG. 2;

FIG. 13 is a block diagram of a computer system that can be used in any of the examples herein to implement an automated community to exchange philanthropic information, such as the philanthropic community meeting place as shown in FIG. 1A.

### DETAILED DESCRIPTION

### General Considerations

Disclosed below are representative embodiments of methods, apparatus, and systems having particular applicability to automating communities to exchange philanthropic information. However, such application should not be construed as limiting the scope of the present disclosure in any way. Instead, the present disclosure is directed toward all novel and nonobvious features and aspects of the various disclosed methods, apparatus, and systems, and their equivalents, alone and in various combinations and subcombinations with one another.

### EXAMPLE 1

### Exemplary System for Automating a Community to Exchange Philanthropic Information.

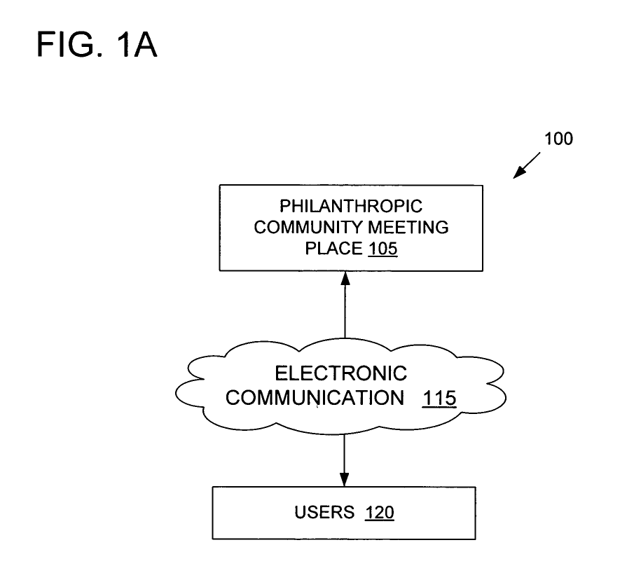

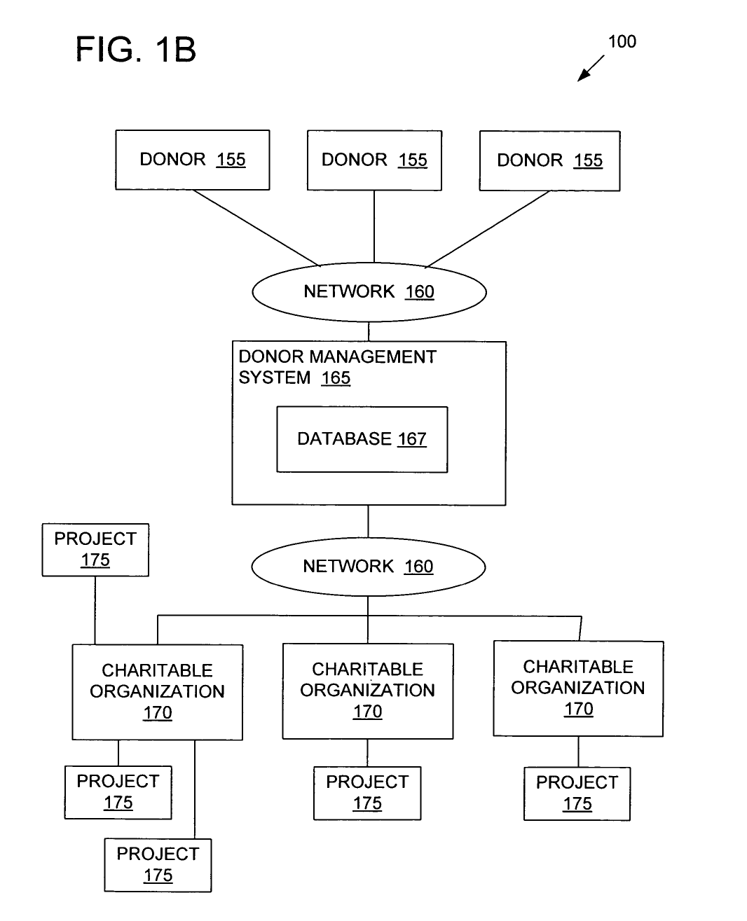

With reference to FIG. 1A, in certain embodiments, the present invention provides methods and systems for facilitating an online philanthropic community meeting place 105. Embodiments of the online community meeting place allow users 120, which may be donors, charitable organizations, and others to procure, discuss, and share information through real-time or other electronic communications 115. The philanthropic community marketplace 105 can be embodied in software and can incorporate databases, interfaces, and other well-known and/or commercially available packages, and can employ any combination of the technologies described herein. Electronic communications can be any transfer of signs, signals, writing, images, sounds, or data, transmitted in whole or in part by a wire, radio, electromagnetic, photoelectronic or a photooptical system, such as through one or more networks, which may be an intranet or the Internet. The one or more networks may also be a geographically confined networks, entity-specific networks, or other networks, including intranets of corporate, education, hospital, or religious institutions, governments, or other systems. This might reduce access to and reach of the community while meeting other objectives such as restricting access to only desired participants that utilize such a non-web-based or intranet network.

Donors may be individuals, businesses, philanthropic organizations, or wealth managers. Charitable organizations include, without limitation, nonprofit organizations, religious organizations, aid organizations, health organizations, environmental groups, and other philanthropic causes. Charitable organizations also includes members of such organizations, such as project managers, task managers, and the like. Examples of charitable organizations include, for example, and without limitation, the United Way, the Sierra Club, Campus Crusade for Christ, the World Health Organization, and the Salvation Army.

Electronic communications, such as online communication, may include one or more blogs, a chat feature which may include one or more chat rooms, email mailing lists, an electronic bulletin board, and the like. For example, the chat feature may be included as an integrated component of a donor management system, or may access the donor management system through one or more links. The chat feature allows users to connect to a virtual community to view, meet, share, and discuss information about charitable organizations, charitable projects, philanthropic opportunities, and other topics.

With reference to FIG. 1B, in an exemplary embodiment, the donor management system 165 maintains information on charitable organizations 170, each of which may have one or more projects 175 or endeavors that they are undertaking and wish to obtain donation to support. The charitable organizations 170 may use the donor management system 165 using a network 160 or other communications system to input a variety of information, which may be input into a database 167, all or a portion of which can be displayed to the donors 155. This information may include anything related to the charitable organization or its projects. The charitable organization 170 may refer to members of the charitable organization 170 acting on its behalf.

The donor management system 165 may have one or a plurality of components. For example, the donor managements system 165 may have a first portion (not shown) accessible to the donors 155 and a second portion (not shown) accessible to the charitable organizations 170. In this embodiment, the donor management system 165 integrates the first and second portions. In other embodiments, the donor management system 165 is unitary in structure, accessible to both the donors 155 and the charitable organizations 170. Of course, certain features and/or functions of the donor management system 165 may be limited to either the donors 155 or the charitable organizations 170.

For example, the information may include information regarding the nature of the charitable organization 170, ongoing or past activities or projects of the charitable organization 170, the level of funding of the charitable organization 170 as a whole or the level of funding for individual projects 175, and general financial data. In certain embodiments, the charitable organizations 170 may add or remove projects 175 from the donor management system 165 and update the information stored in the database 167 in the donor management system 165, such as providing progress reports for projects 175, and providing updated financial data.

The donors 155 may review all or a portion of the information on the charitable organizations 170 and projects 175. In certain embodiments, an interactive brochure, such as one or more web pages, may be created for each charitable organization 170, providing a convenient way for donors 155 to gather information about the charitable organizations 170. Similarly, in certain embodiments, the donor management system 165 presents information related to the projects 175 to the donors 155 in the form of an interactive brochure.

A donor 155 may choose to donate to a particular charitable organization 170, or to a particular project 175. The donation may be made to the chosen beneficiary utilizing the donor management system 165.

A donor 155 may choose to donate to a particular charitable organization 170. In certain embodiments, a donor may choose to donate to a particular project 175 of a charitable organization 170. The donation may be made directly to the charitable organization 170 or through an intermediary (not shown). The donor 155 may choose to be anonymous or make his or her identity known to the charitable organization 170. If the donor 155 desires to remain anonymous, the donation may first pass to the intermediary, who then remits the donation to the charitable organization 170. This anonymity may also be created through the use of a registration process, discussed with reference to example 7, that allows the donor to sign onto the donor management system using an alias. The donor management system 165 knows details about the donor 155, such as the donation account discussed below, which allow it to make an anonymous donation for the donor 155 while keeping his or her identity hidden.

The donor management system 165 may provide the donor 155 with a donation account. The donor 155 may place funds in the donation account for storage until the donor 155 desires to donate to a charitable organization 170 or project 175. While the funds are in the donation account, they may be invested by the donor management system 165 for the benefit of the donor 155 or a third party, such as a charitable organization 170 or project 175 designated by the donor 155.

The disclosed donor management system 165 may be implemented on any suitable platform. For example, the donor management system 118 may be implemented on a Microsoft-centric server platform, running Windows Server 2003. The system is built on the Microsoft ASP.NET 2.0 development platform and supports cross-platform and dynamically compiled and optimized code.

The ASP.NET compiler is backed by a framework supporting a large number of objects and functions. These technologies support rapid development and a flexible testing and deployment environment. Additionally, these ASP.NET and related framework technologies can run on Linux/Unix if desired.

### EXAMPLE 2

### Exemplary Users of the Community Meeting Place.

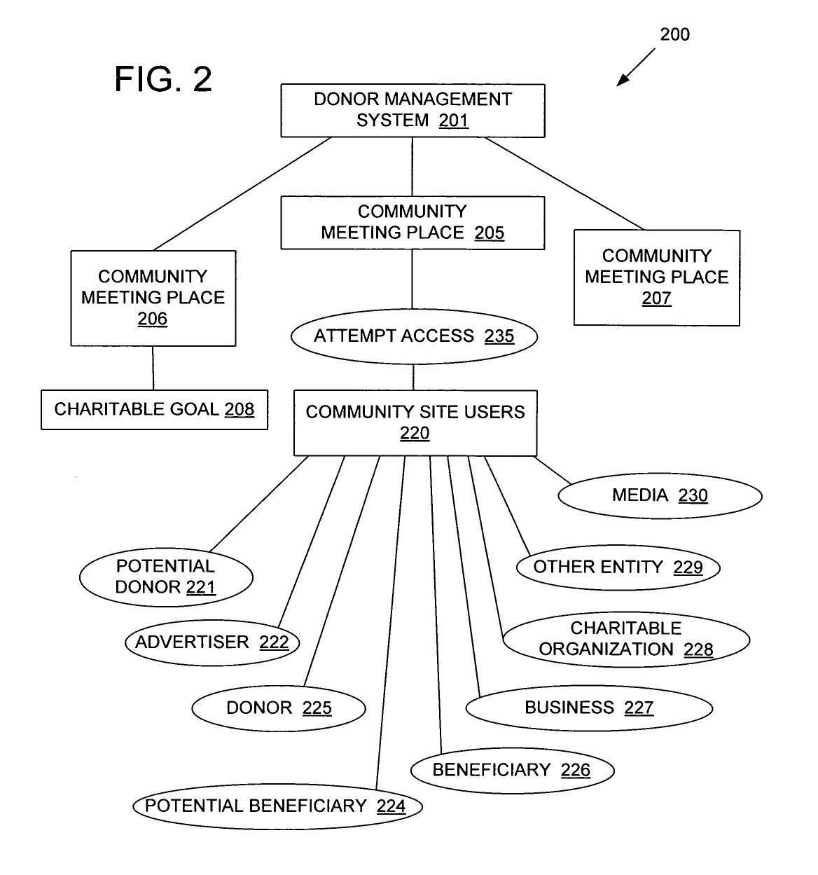

FIG. 2 describes a method of accessing a community meeting place. In any of the examples herein, the users of the community meeting place can correspond to any of the people or organizations listed in FIG. 2, or may correspond to other people or entities. The method of FIG. 2 can be performed, for example, by the system 100 of FIG. 1A. The method 200 and any of the other methods described herein can be performed by computer-executable instructions stored on one or more computer-readable media. At 235 one of a number of users 220 attempts to access a community meeting place 205. The community meeting place 205 may be associated with a donor management system 201, such as the donor management system 165 of FIG. 1B. The donor management system 201 may have multiple community meeting places 205, 206, 207 associated with it. Each community meeting place 205, 206, 207 may be associated with a specific project 175 (FIG. 1B), a specific charitable organization 170 (FIG. 1B), a specific donor 155 (FIG. 1B), or may be associated with a set of donors, charitable organizations and/or projects. Also, the meeting place 205, 206, 207 may be user defined, etc.

For example and not limitation, a user 220 can be a donor 225 who has previously donated to a project which may be managed within a donor management system 201, a charitable organization 228 who may track projects through the donor management system 201, a potential donor 221 who has not yet donated to a project within the donor management system 201, a beneficiary (donee) 226 who has received help directly or indirectly from a donor 225 or a charitable organization 228, or a potential beneficiary 224 who may receive aid if a specific project is funded, or if a charitable organization 228 receives funds.

A community meeting place, such as community meeting place 205, may be associated with a specific user 220 or group of users, such as a donor 225, who then may be able to set the community site up, specifying, for example, a charitable goal 208 that the community meeting place 205 may work toward. Such goal may be very specific, such as “supply $20,000.00 to a specific elementary school”, very general, such as “influence world peace”, or may be somewhere between. Some community sites may have multiple goals. An individual community site may also have an approved list of projects 170, charitable organizations 175, advertisers, and so forth. In such a case, a search function may be available at the community site that allows members of the community site to access information stored in a database, such as the database 167 (FIG. 1) associated with a donor management system, such as the donor management system 165 (FIG. 1). The search function may only allow members present at the site to search for information about projects, charities, etc. which are on the approved list.

Community sites may be able to donate to charities as a group; that is, the community site itself may make a donation in the name of the community site, the donation funded, at least in part, by individual members of the community.

A community site, such as the community site 205, may be personalized. That is, a community site user 220 or users may have special access which allows them to change the look of the site. The user 220 may be able to, for example, choose a “skin” (a custom graphical appearance) for the community site 205.

Community sites, such as the community site 205 may be private, in that it limits access to the site, such as, for example, and not limitation, by requiring a password to enter.

Entities which are not directly involved with charitable activities may also access the community meeting place 205. Such entities may include businesses 227 which may provide matching funds for charitable giving in general or for specific charities or projects. They may also include advertisers 222 which may provide advertising banners displayed within the community meeting place 205 or donor management system 201, signatures appended to chat and email messages, and other forms of electronic advertising accessible to other users of the community meeting place 205.

Media 230 may also be interested in accessing the community meeting place, and may be invited by donors 225, charitable organizations 228, etc., to report on ongoing projects, and so on. Other entities 229 may also have occasion to visit and access the community meeting place 205.

### EXAMPLE 3

### Exemplary Online Communication Within the Community Meeting Place.

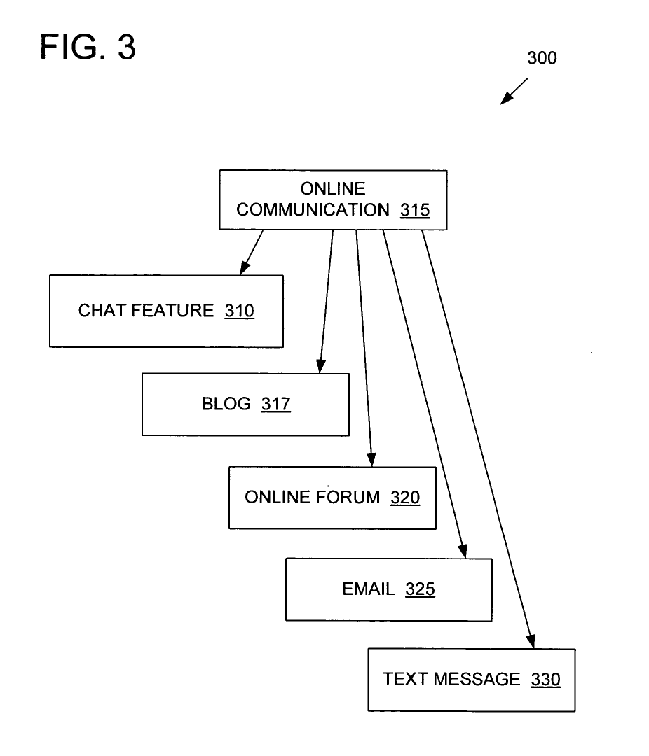

With reference to FIG. 3, online communications 315, such as the electronic communications 115, can comprise a wide variety of synchronous and asynchronous communications types. For example, and not limitation, online communications 315 may comprise chat features 310, blogs 317, online forums 320, email mailing lists 325, text messages 330, streaming video, streaming audio, and/or podcasts (not shown). These features may be provided using commercially-available packages, or using innovative systems developed specifically for use in a charitable environment.

The chat feature 310 includes chat rooms—online rooms which allow people to communicate in real time, or chat. Chat rooms may be public, or semi-public, in that the room may have many users, each of whom can see everyone else's conversations. The chat feature may also incorporate private rooms where two (or more ) users 220 (FIG. 2) can chat privately. One or more chat rooms may be moderated, users 220 may be banned, by moderators, by other community site users, and so forth. A chat room may have a background that appears to be a room, or have other, distinctive graphics associated with it. In such a case, an “owner” of the chat room, who might be an administrator of a community site 206, such as a donor, may personalize the look of a chat room. Chat rooms could restrict access to a specified list of users. Such a restricted list may be set up by the community, by an “owner” of the community site who has administrator privileges, and so forth, as known to those of skill in the art. Specific users could be banned, based on disruptive behavior, failure to follow community procedures, and so forth.

Blogs 317, also known as weblogs, are websites which may be associated with a particular person or entity and which contain entries, such as journal entries, generally in reverse chronological order. The blogs 317 may allow comments, so that people other than the blog owner(s) may also leave comments. The blogs 317 may not be restricted to text messages, but may also include video and audio links as well as links to other network sites of interest potentially both inside and outside a philanthropic community meeting place 105 (FIG. 1).

An online forum 320, also called an Internet forum, a message board, etc., may be an online message board which allows members of a community to create threads, that is, areas of discussion, and to reply to other's threads. This allows asynchronous communication at a known location so that members of a community can talk to each other at times convenient to them. The online forum 320 may be moderated, and may allow individual users to block other users and/or to speak only to a subset of the potential users of the online forum.

An email mailing list 325 may be provided which allows messages to be sent to members of a mailing list (an announcement list) and which generally restricts posting on the list to those with special permission. An email discussion list 325 may also be provided which may be set up around a particular topic of interest such as a charity, charitable project, etc. Email mailing lists 325 may have spam filtering, and may be moderated, may archive messages, and so forth.

Podcasts, also known as webcasts, are audio and/or video information available for download, such as, for example, from the community site 205. Such information may be streamed or directly downloaded. Individual podcasts may be developed for specific charities, or for projects within the charities. Podcasts may also be developed around community goals, or beneficiaries, for donors, etc. Access to podcasts could be restricted to a select group of users, and so on.

A text message list can be a list of phone numbers or other communications numbers of like-minded community site users 220. Messages of interest to the community could be broadcast to the group through the use of text messages that would be sent to the user's 220 phones, PDA's, computers, etc. As with all of the online communications 315, the implementation is not designed to be restricted to a specific embodiment.

### EXAMPLE 4

### Exemplary Online Communications Embodiment.

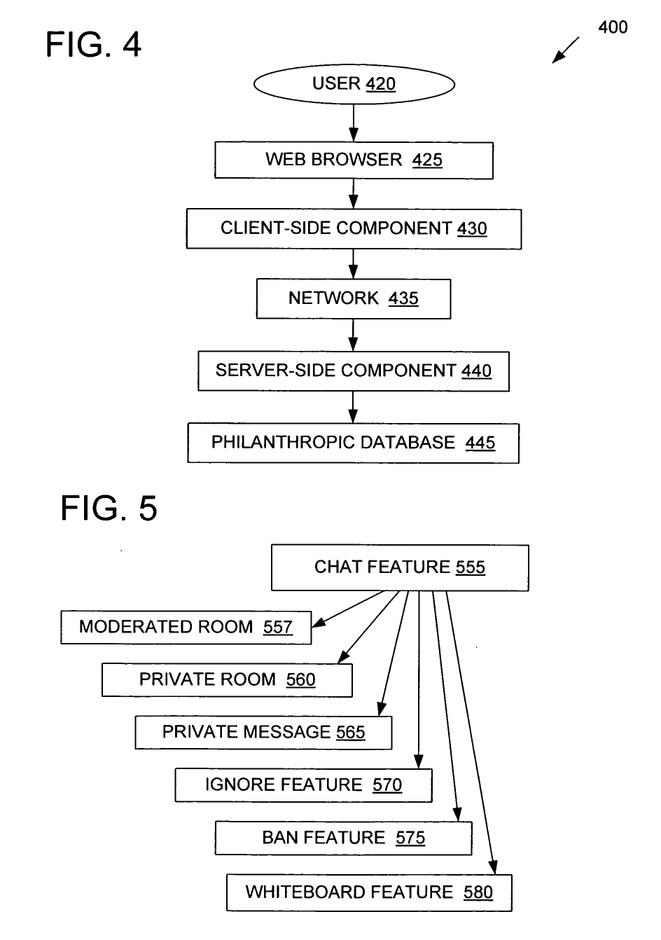

With reference to FIG. 4, in some embodiments, online communications, such as, for example, and not limitation, the chat feature 310 (FIG. 3), includes a server-side component 440 and a client-side component 430. The server-side component 440 may connect to a database 445 through a network 435 to store and manage data used in online communications, such as chat data. In general, this component 440 is controlled by operators of a donor management system, such as the donor management system 401 (FIG. 4.) In some embodiments, the server-side component 440 may be web-based and written in a scripting language such as, for example, and not by way of limitation, Perl, PHP, ASP, JSP, ColdFusion, ASP.NET, etc. In other embodiments, the server-side component 440 is a separate program running on the server. Notably, the server-side component may be distributed over multiple computers, or, it may be set up as a peer-to-peer based system or in some other way.

Users 420 may connect to an online communications feature, such as, for example and not limitation, a server 440, via the client-side component 430. The client-side component 430, in some embodiments, may be initiated from a web browser 425. Or, the client-side component 430 may be run as a separate client program. Alternatively, the chat feature may be implemented in some other way.

The online communications feature further comprises a graphical user interface which itself includes browser or web pages. These pages may be built, for example, and not limitation, using a combination of HTML, JavaScript, Cascading Style Sheets, and Active Server pages.

### EXAMPLE 5

### Exemplary Online Chat Feature Embodiment.

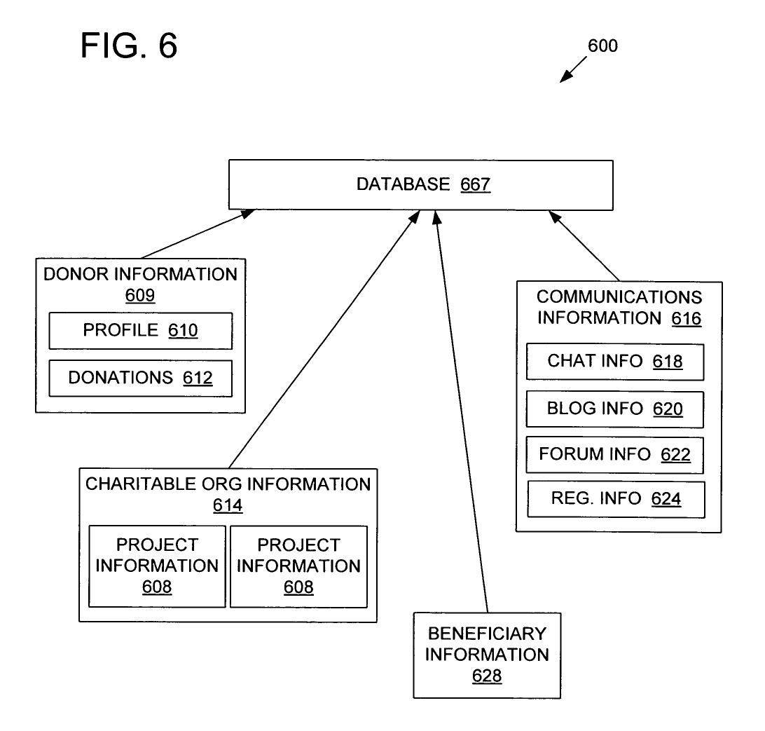

With reference to FIG. 6, in some embodiments, the chat feature 655, which may be a chat feature 333 (FIG. 3) may be implemented as a chat program. In general, a chat program allows people to exchange information in real-time over networks 435 (FIG. 4), such as an intranet or the Internet. A chat program creates a virtual room which allows people from all around the world to talk to each other with everybody in the room being able to “hear” (read) everyone else's conversation and join in at any time. Traditionally, most chat is text based, but can also involve audio and video.

Other features in the chat feature of the community site may include but are not limited to: moderated discussions (e.g., all the messages in a moderated room 557 are passed through a moderator), private rooms 560 (e.g., no other user can enter the room, unless they were invited by the room owner), private messages 565 (e.g., allows sending a message to a single person only and no other user in the room will see the message), an ignore feature 570 (selectively ignore comments by specific users), ban feature 575 (e.g., ban users by name or IP address), organizational control hierarchy, language filters, text formatter, user interface customizer, integration with existing donor management system databases 667 (FIG. 6), HTTP tunneling (e.g., allows working through firewalls and proxy servers), whiteboard feature 580 (allow diagrams to be drawn within a chat room which all (or a selected group of) chat room users can see), file transfer capabilities, application sharing, email notification of scheduled chat, calendaring notification of scheduled chat, and other features.

By implementing access to electronic communications 115 (FIG. 1a), such as any of the online communications 315 (FIG. 3), donor management systems provide a community meeting place for procuring, viewing, sharing, managing, and exchanging information on charitable, philanthropic, or other projects and/or organizations. In at least some embodiments, users need not be donors or have any connection to the donor management systems. In an exemplary embodiment, anyone interested in a charitable organization or other cause may come to a community meeting place 205 (FIG. 2) and participate. In some exemplary embodiments, the chat feature is restricted to users of a community meeting site 220 (FIG. 2), or restricted in some other way, such as access is only available to those with permission to enter, as is shown for example, with respect to example 7.

In another exemplary embodiment, the chat feature also provides access capability for discussing potential projects and organizations with those in charge of such projects and organizations.

### EXAMPLE 6

### Exemplary Database Implementation.

With reference to FIG. 6, in some embodiments, a database 667, such as the database 167 (FIG. 1B), stores and retrieve information about various philanthropic activities, donors, charitable organizations, etc. It may also store information about electronic communications made within a community meeting place, such as the community meeting place 105. As an example and without limitation, the database 667 may store information about donors 609. This donor information 609 may be further divided into a profile 610, which may describe basic information about a donor, such as general philanthropic goals and areas of interest, and information about specific donations 612. The donor profile may contain information regarding the types of charitable organizations 170 (FIG. 1B) or projects 175 (FIG. 1B) the donor 155 (FIG. 1B)is interested in finding. For example, the donor 155 may be interested in funding a particular religious or environmental cause, such as protecting Lake Tahoe, for example. Each of the donors 155 may have a number of types of charitable organizations 170 or projects 175 they are interested in, each of these preferences may be stored in the profile of the donor 155.

Charitable organization information 614 may also be included, which might include information about specific projects 608 for which the charity is soliciting funds, information about how much funding a specific project has received, information about beneficiaries to a project, and so on.

Information about beneficiaries 628 to projects funded through the community meeting place 105 (FIG. 1A) may also be included in the database 667 as a separate category, the beneficiary information 620 may be considered a subset of the project with which they are associated, or a different method known to those of skill in the art may be used.

Information about electronic communications 616 may also be kept in the database 667. For example, the chat feature 555 (FIG. 5) may allow users to save their individual conversations. It may also allow users to have specific preferences set when they enter a chat room. The chat feature may also archive all (or a portion of) the chats, to be available later. Such features, and others, may all be saved in a chat information section 618 of the database 667. Similarly, information about blogs 620 including blog entries, and/or online forum information including forum entries 622 may also be saved. A search feature may also be provided which allows users to search for information about community site users 220 (FIG. 2), or other information in the donor management database 167 (FIG. 1B.) Any of the electronic communications may require registration. The registration information 624 may also be saved within the database 667.

The database, in whole or part, may be searchable. In such a case, a set of search keys may be created for each charitable organization 170 (FIG. 1B) and/or project 175 (FIG. 1B). The search keys may contain a number of elements related to the charitable organization 170 or project 175. For example, the search keys may include elements such as keywords, categories, budget, secularity, location, management, media coverage, number of projects, and similar factors.

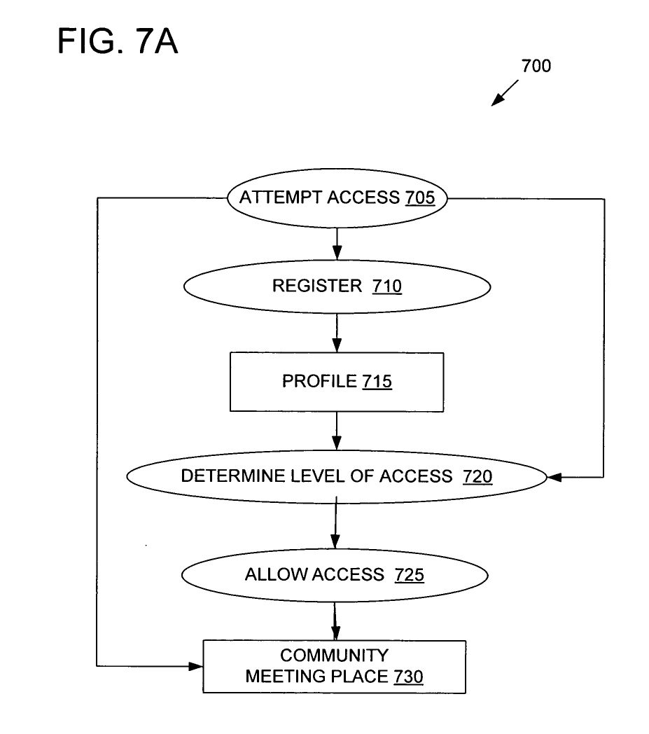

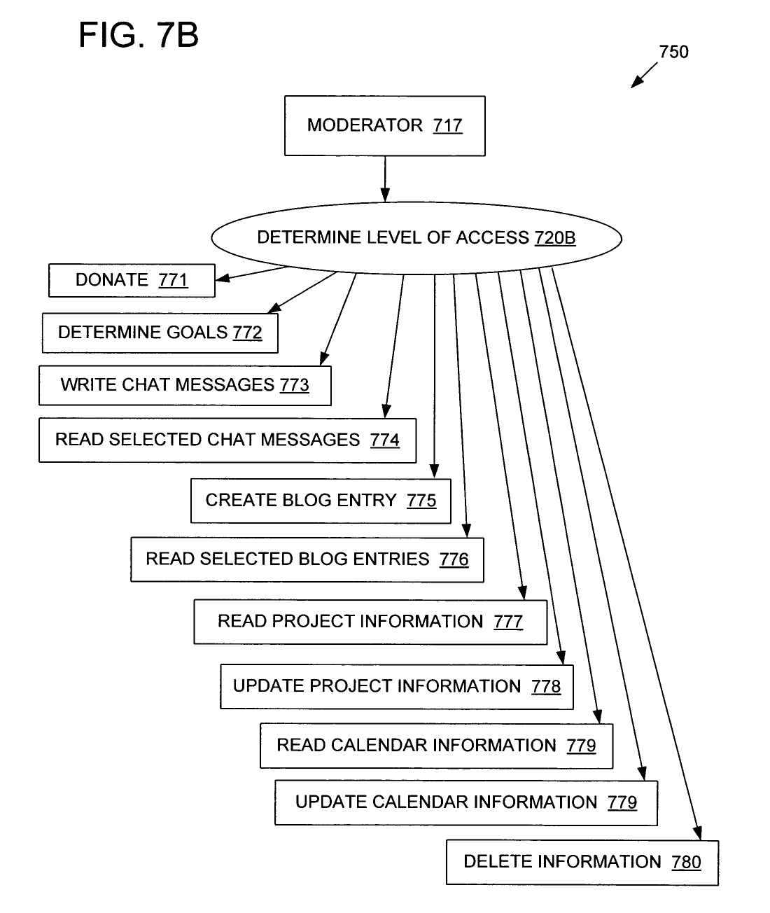

Searches may also be performed for donors 155 (FIG. 1B). Information gleaned through online communications 315 (FIG. 3) such as blog postings, chat room conversations and the like can be stored in the database and used in the searches. Similarly, the donor profile, created, in an exemplary embodiment, during registration 710 (FIG. 7A) may also be stored in the database and used for searches.

Certain embodiments allow the donors 155 to find charitable organizations 170 or projects 175 of interest by searching one or more elements of the search keys. For example, a donor 110 could perform a keyword search to find matching charitable organizations 134 or charitable projects 140. Alternatively, a donor 110 could choose to sort or view all charitable organizations 170 or projects 140 within a particular category, such as all environmental charitable organizations 134 or all charitable projects 140 involving Lake Tahoe. This process may be reversed, allowing the charitable organizations 170 to locate donors 155 based on donor preferences stored in the donor profiles.

The selection process may be automated, with the donor management system 165 automatically comparing donor profiles to search keys using various schemes to provide the donors 155 with a list of the charitable organizations 170 or the projects 175 most likely to interest them. Similarly, a search can be performed to, for example, provide the charitable organization 170 with a list of the donors 155 most likely to make a donation. These searches may be updated periodically, may be updated when new information is received, may be updated when an event occurs, etc., to call recently added or modified charitable organizations 170 or projects 175 to the attention of matching donors 155, or to call recently added or updated donors 155 to the attention of the charitable organizations 170.

The database 667 itself, by way of example and not limitation, may have, at least in part a hierarchical architecture, may be a relational database, such as, for example, a SQL database, may be an object oriented database, may be a dimensional database, or may be any other appropriate database or combination of databases as known to those of skill in the art. For example, the database may be implemented as an XML database to facilitate network use. Databases may also combine different architectures.

If a SQL database is used at least in part, it may utilize Microsoft's SQL Database Server. It also may comprise a series of tables that contain rows and columns that identify and define the data in the SQL database. It may utilize stored procedures for performing many database related functions such as insets, updates, and deletions, as well as queries by users, such as the users 120 (FIG. 1) and the system.

SQL Server 2000 integrates with the other platform technologies and provides online transaction processing (OLTP) database functionality. The donor management system 165 may thus maintain a real-time online processing database. For more involved online application processing (OLAP), Oracle database products can be supported by the platform via a system-wide data abstraction layer.

### EXAMPLE 7

### Exemplary Method to Access the Community Meeting Place.

In some embodiments, user registration may be required to access one or more online communications features 315 (FIG. 3). For example, to access a community meeting place 205 (FIG. 2) and its chat features, a user may be required to register with the operating donor management system, such as the donor management system 165 (FIG. 1B) before access is granted to the community. Alternatively, some community meeting places may not require registration, so users may browse the site in relative anonymity.

With reference to FIG. 7A, at 705 a user, who may be any of the users mentioned in example 2, attempts to access a community meeting place, such as the community meeting place 205 of FIG. 2. In some embodiments, access to participate in a community meeting place is granted to users that have registered with the corresponding donor management system 165 (FIG. 1B). At process block 710, the user is registered. In some embodiments, registration is not required, and so immediate access is allowed to the community meeting place 730. In other systems registration is required, in which case, a profile 715, which may be stored in the database 667 (FIG. 6) is generated, or retrieved from the database 667.

In some embodiments, a user creates a profile 715, which may be a donor profile. The donor profile may contain information regarding the types of charitable organizations or projects the donor is interested in funding. In an exemplary embodiment, the profile 715 provides, for example, an operator of the donor management system 165 (FIG. 1B) with information, such as name and email address, so that they can make follow-up inquiries of the user.

Other personal information may also be included in the profile 715, such as an estimate of probable donations by the user for a time period, (such as a year) and specific donation information (such as bank account numbers), which can be used to facilitate easy donation to a desired charitable organization 170 (FIG. 1B) or charitable project 175 (FIG. 1B) by the user. During registration, a user may also be able to set up an alias, or aliases, which allow the user to communicate anonymously with other members of the donor management system 201 (FIG. 2) or of a specific community meeting place 206 (FIG. 2). Such anonymity may be used to protect the user's privacy, but is also a way for an administrator of a community meeting place to monitor possible disruptive behavior of individual members, and discipline them privately.

Based on the profile information (in some embodiments), access may be granted to certain chat communities, which allows a user to learn more about an organization before donating to it. Similarly, based on the donor profile 715, charitable organization may seek and invite potential donors to join their community to learn more about their organization and discuss on-going and future projects. Moreover, the donor profile 715 allows the community meeting place 205 (FIG. 2) to display advertisements and links to donor management systems, charitable organizations, businesses, and/or other sites that may be of the most interest to the user.

At process block 720, the level of access allowed for a user is determined. For example, in some embodiments, certain features of online communication 315 (FIG. 3) such as a chat feature 555 (FIG. 5) may be limited to only donor users 155 (FIG. 1B). In other embodiments, other criteria may be used. For example, charitable organizations 170 (FIG. 1B) typically have one or more projects or endeavors 175 (FIG. 1B) that they are undertaking at a given time and may wish to limit access to a community meeting place 205. Examples of limited access, for example and not limitation, may include limiting access to a particular type of entity, to those people who have donated to a specific project, to those people who have donated more than a certain amount of money, etc. In other words, a number of other ways may be used to determine who has access to certain features with a given online community. In some embodiments, a charitable organization, or an organization acting on behalf of a charitable organization, manages access to these and other features.

Once the level of access has been determined, at 725, access at the determined level is allowed to the community meeting place 730.

### EXAMPLE 8

### Exemplary Method to Determine Level of Access at the Community Meeting Place.

FIG. 7B shows an exemplary method 750 to determine the level of access to the community meeting place. The method of 750 may be performed, for example, by the donor management system 175 of FIG. 1B. With reference to FIG. 7B, when a user attempts to access the community meeting place, a level of access is determined for the user at 720B. This level of access may be chosen by a moderator 717, which may be a person charged with such a responsibility, or the level of access may be chosen automatically by software implemented to perform such a duty. The level of access may be based on the type of community meeting place user someone is, as shown at 220 in FIG. 2. For example, a donor 225 (FIG. 2) may be given a different level of access than a charitable organization (or a member thereof) 228 (FIG. 2). Level of access may be based on community rating, that is, different members of the community may be able to rate users. For example someone who otherwise would be allowed access may be “troll rated” for improper behavior and denied access or given only limited access. Access may be based on invitation, that is a member in good standing may be allowed to invite a new participant to join the community, or level of access may be based on different criteria.

A variety of different levels of access may be allowed. For example and without limitation, someone with a high level of access may be allowed to determine goals for the community 772, read calendar information 779, update calendar information 780, delete information 781, create a blog of interest to the community, decide levels of access, and so on. Other levels of access, for example and not limitation, may allow donation 771 to a project or projects that the community is built around or donation to other projects, write chat messages 773, read all or selected chat messages 774, read all or selected blog entries 776, read project information, which may include access to a search feature allowing perusal of information about the charity involved with the project, people (donors, potential donors, beneficiaries, potential beneficiaries, businesses) associated with the project, and so forth.

### EXAMPLE 9

### Exemplary Method to Register at the Community Meeting Place.

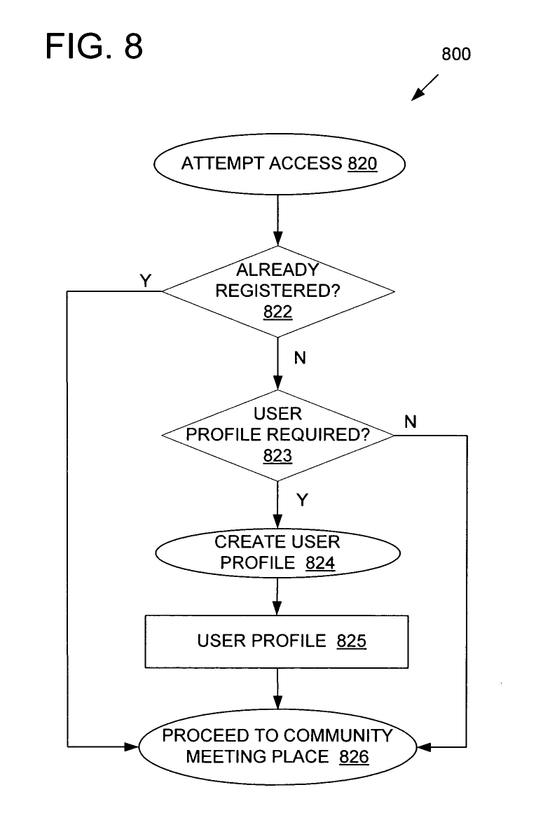

FIG. 8 at 800 shows an exemplary method for registering at the community meeting place. The method of 800 may be performed by the donor management system 175 of FIG. 1B. With reference to FIG. 8, when registration is required, a user attempts access 820 to the community meeting place, such as the community meeting place 205. At decision block 822, it is determined if the user attempting access is already registered. If so, then the process continues at process block 826. If the user is not registered, the process continues at decision block 823. At decision block 823 it is determined if a user profile is required. If so, then the process continues at process block 824. If not, the process continues at 826. At process block 824, a user profile 825 is created, such as the user profile 715 (FIG. 7A). The user profile can include information such as an alias or aliases that the user will be known as during online communications 315 (FIG. 3). This can protect the privacy of an individual who, for example, may prefer to donate anonymously. The user profile 825 may also include desired avatars, which can be a graphical representation of the user, used, for example, to visually identify a user during chatroom 310 (FIG. 3) chat or when posting to an online forum 320 (FIG. 3), etc. At process block 826 the user proceeds to the community meeting place.

### EXAMPLE 10

### An Exemplary Community Meeting Place.

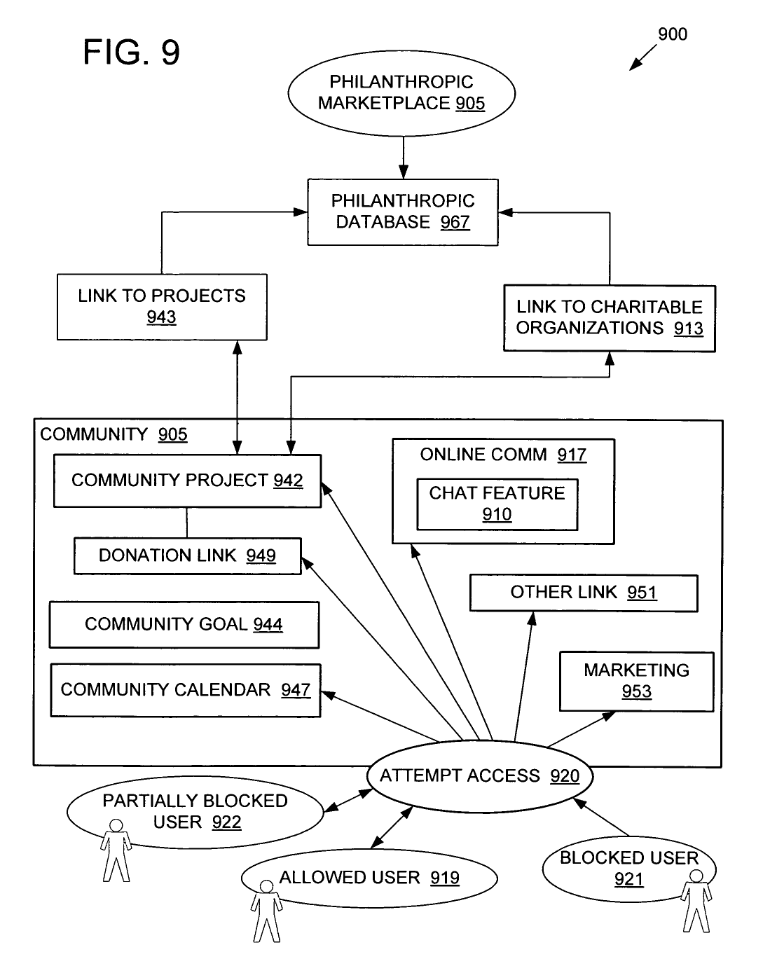

FIG. 9 at 900 shows an exemplary community meeting place which can be used in any of the examples herein. FIG. 9 comprises a philanthropic marketplace 905 in which a group of like-minded individuals, such as donors, beneficiaries, and others may communicate openly about how philanthropic donations are to be used. The community meeting place's online communications 917, such as a chat features 910, allow donors, beneficiaries, and others to communicate openly, including about how philanthropic donations are to be used, how much money needs to be raised, what the plans are for future donations, and other topics. Moreover, online community users 220 (FIG. 2) such as charitable organizations 228 (FIG. 2) may use electronic communications 115 (FIG. 1A) such as the online communications 917 to post information, such as, for example and not limitation, progress reports, information regarding the nature of the charitable organization, ongoing or past activities or projects of the charitable organization, the level of funding of the charitable organization or projects, financial data and other relevant information, all or a portion of which can be displayed to other members of the community 220 (FIG. 2).

To allow users to feel comfortable asking what may be difficult questions, the community 905 may have specific site access requirements, as discussed with reference to FIG. 7. As such, in an exemplary embodiment, there may be three types of users who attempt to access the community 905 at process 920: i.e., users who are completely blocked 921, users who are partially blocked 922, and users who are allowed 919, that is, allowed to enter and interact within the community. Users may be blocked 921 based on individual IP address, that is a specific user may be disallowed from entering the community based on past behavior—i.e., if the user has exhibited troubling behavior within chat rooms 310 (FIG. 3), blogs 317 (FIG. 3), or forums 320 (FIG. 3). Users may also be blocked based on community preference, based on donor or charitable organization preference, or for another reason. Users may be partially blocked if, for example, some blogs 317 (FIG. 3), online forums, chat rooms 910, etc., allow admittance based on specific criteria, such as prior donation, interest in a community goal 944, interest in a community project 942, invitation by current member, etc.

Communities 905 may have a community goal 944. This goal 944 may be determined by members of the community, or by other means, such as by a charitable organization 228 (FIG. 2) associated with a community project 942. The community project 942 may be a specific project 175 (FIG. 1B) associated with a specific charitable organization 170 (FIG. 1B), may be a group of projects 175 (FIG. 1B) from several organizations 170 (FIG. 1B) with a similar community goal 944, or may be organized around different criteria, such as all projects of a specific donor 155 (FIG. 1B), charitable organization 170 (FIG. 1B), etc.

Communities 905 may be organized around many different eleemosynary criteria: for example, a community may comprise the donors 155 (FIG. 1) and beneficiaries 226 (FIG. 2) of a specific project, all projects of interest to a specific donor 155 (FIG. 1B), all projects of a specific charitable organization 170 (FIG. 1B), projects located within a geographic area, around a specific goal, etc.

A community calendar 947 may be provided. This calendar 947 may be updated by members of the community with authority to do so, and may provide a way to build community, for example by allowing a simple way for community members to schedule, and thus, attend, events and activities.

A community project 942, which may be a project 175 (FIG. 1B) associated with a specific charitable organization 170 (FIG. 1B), may have a link 949 which allows donation to the community project 942 by a community member, such as the users 919 and 922. The link 949 may be through a secured system which allows a potential donor to donate safely. The link 949, and/or the project 942 may, in turn, be connected 913 to the charitable organization 170 (FIG. 1B) related to the project or other charitable organizations 170 (FIG. 1B). The community project 942 may also be linked 943 to other projects 175 (FIG. 1B) stored in a philanthropic database, such as the database 167 (FIG. 1B) associated with the data management system 165 (FIG. 1B).

Thus, embodiments described herein provide systems and methods that allow virtually anyone to communicate in a centralized location about philanthropic projects, charitable organizations, or other topics in general with virtually anyone else.

Preferably, the online community meeting places 205, 206, 207 (FIG. 2) are associated with a donor management system 201 (FIG. 2). Alternatively, a community meeting place, such as the community 905 may provide links 951 to other donor management systems, charitable organizations, businesses, philanthropic projects, etc.

In certain embodiments, the community meeting place 905 also provides a mechanism for marketing 953 such as marketing other charitable organizations, philanthropic organizations, businesses, and others. Marketing 953 may be done through banners, click-through links to websites or donor management systems, written materials, online brochures, etc. At community sites, such as the community meeting places 205, 206, 207 (FIG. 2), community site users 220 (FIG. 2) such as charitable organizations 228 (FIG. 2), businesses 227 (FIG. 2), advertisers 222 (FIG. 2), and others may advertise to attract donors and other entities to actively participate in and/or take advantage of their products and services.

Links 951 to sites outside the donor management system 201 (FIG. 2) may also be provided within a community site 905. For example, a community site 905 discussing humanitarian aid projects to flood victims may contain links to various approved charitable organizations and/or donor management systems. Similarly, a donor management system 201 associated with providing medical services to people in Latin America may display links to one or more community sites 905 that discuss ways in which users can help provide medical services to needy people in Latin America. Preferably, a community site 905 is directly linked to a donor management system 201, thereby, facilitating community members, such as the community site users 220 (FIG. 2) to migrate to a charitable organization's 170 (FIG. 1B) or philanthropic project's 175 (FIG. 1B) donation site, such as the donor management system 165 (FIG. 1B).

In some embodiments, other donor management systems 201, and potential community site users 220 such as charitable organizations 228 (FIG. 2), advertisers 222 (FIG. 2) and businesses 227 (FIG. 2) can advertise at the community sites, as well. For example, if a business 227 offers to match a certain number of donations, the charitable organization 228 may want to place a banner on the community site 905 to feature the business 227 as a key sponsor of a project 175 associated with the charitable organization 228 and may also recommend that business 227 to community site users 220. In some embodiments, donor management system operators may charge third parties for advertising in the community site 905. By doing so, the community site 905 may generate additional revenue for its charitable organization 228 or philanthropic project 175. Moreover, these marketing mechanisms allow businesses 227 and other third parties 229 to actively sponsor and show their support for good causes—creating goodwill and enhancing the reputation of the business 227.

A community 905 may be associated with a community site user 220 (FIG. 2), such as a donor 225. This user may be allowed to control many aspects of the community site, such as for example, personalizing the site. Personalization may include, for example and not limitation, aspects about the philanthropic nature of the site, aspects about the appearance of the site, and other aspects. Aspects about the philanthropic nature of the site include but are not limited to: defining the community goal or goals 944, setting up the online communication features 351 (FIG. 3), allowing or disallowing aliases, scope of search engine searches and so forth. Aspects about the appearance of the site include, for example, the appearance of GUI features, such as buttons, labels, drop-down menus, and the like. Appearance of the webpage served back to a user from the community site could also be personalized, such as with, for example, a backdrop, such as a picture related to the community goal or another picture or pattern chosen by a site administrator, a logo of a business associated with the community, and so on. Advertising space may be sold on the community site. The proceeds from such sales may be used to at least partially fund a community goal, project, charity etc. Furthermore, such advertisements may be chosen in keeping with the theme of the community site 905.

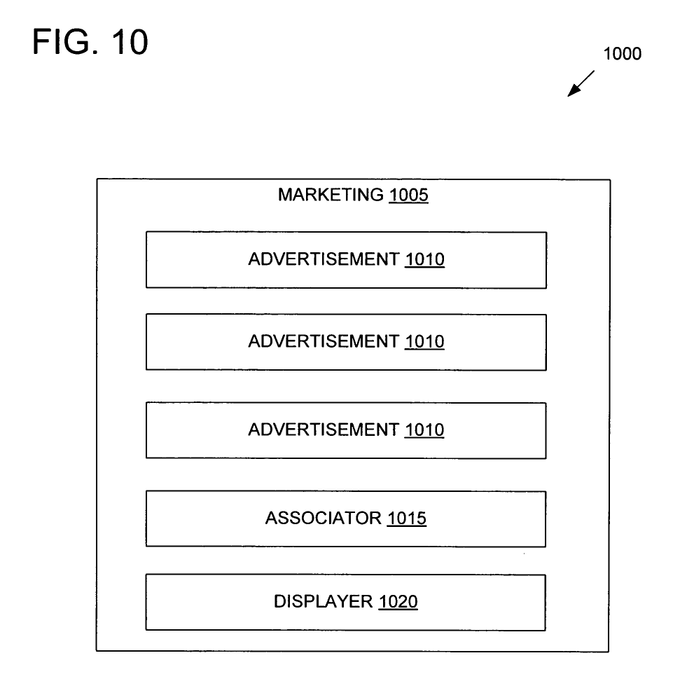

As an example, a community site 905 dedicated to raising money for a humane society may have wallpaper at the community site 905 which includes pictures of animals adopted at the humane society. An animal theme might be chosen for the “look” of the entire site. Advertisements (such as the advertisement 1010 of FIG. 10) might be allowed which, for example advertise cat and dog food or other items associated with pets. Furthermore, an advertiser may use its advertising space to discuss the advertisers dedication to goals important to members of the community site 905, such as by donating a portion of profits to humane societies in various locales.

In at least some embodiments, not only the look and feel of a site 905 is personalizable, but also the functionality. For example, levels of access to the community, number and type of online communications 315 (FIG. 3), and so on, can be modified.

The modifications to such community sites can be performed by someone who is given such rights by an administrator of a website associated with the community meeting place. This might be a donor 225 (FIG. 2) or other user 220 (FIG. 2) of the community site 905 who has at least partial responsibility for the site, may be changeable by multiple users 220, may be changeable by an employee of an associated donor management system 165 (FIG. 1B), and so on.

It should be noted that many features of the present disclosure can have applicability in systems or methods outside of philanthropic activities. It can also be seen that there may be many other aspects of the present disclosure, including many other additional or alternative features.

### EXAMPLE 11

### Exemplary Marketing System

FIG. 10 shows an exemplary marketing system 1000 which can be used in any of the examples herein. The marketing system 1005 may be a marketing system such as the one shown at 953 (FIG. 9). The marketing system 1005 may encompass a series of advertisements 10 10, optionally associated with an advertising module. The advertising module itself is optionally associated with one or more advertisers. These advertisers may associate the advertisements with a charitable goal. This association may be made in many ways. For example, the advertiser could pledge a certain amount to a charitable organization 170 (FIG. 1B) or a charitable project 175 (FIG. 1B). If an advertisement is placed in a community 905 (FIG. 9) and that community meeting place has a community goal 944 (FIG. 9) associated with it, the advertiser could advertise commitment to the community goal 944 by pledging matching donations to the community project(s) 942, a portion of purchase price for advertiser sales donated to the community project(s) 942, (optionally for advertisements 1010 located on the community site 905), and so forth, as understood by those of skill in the art.

Each, some, one or no advertisements 1010 may be associated by, for example, an associator with a user or group of users of the online community. When a user enters the online community, for example, by registering, such as is shown in FIG. 8, the associator may look at information known about the user, such as information stored in the database 167 (FIG. 1B), profile information 610 (FIG. 6), communications information stored in the communications database 616 (FIG. 6) such as chat room information 618 (FIG. 6), blog information 620 (FIG. 6), online forum information 622 (FIG. 6), etc.

The associator may then use the information to determine an appropriate advertisement 1010 to display. The associator may use this information to tailor a specific charitable reward for the individual user, such as, for example, promising a portion of any purchase price to a charitable organization 170 (FIG. 1B) or a charitable project 175 (FIG. 1B) known through, for example, the donor management system database 167 (FIG. 1B) to be of interest to the individual user.

A displayer 1020 may then display the advertisement 1010 in a manner such that the user may see it, such as in a banner advertisement (which links the advertisement to the advertisers website), a static ad, an email, or in another online advertisement known to those of skill in the art. The ad may be built from static images, and/or may be a multimedia object, which may use animation, and/or sound. Other forms of advertising such as, for example and not limitation, opt-in email advertising and/or search engine advertising may also be employed.

### EXAMPLE 12

### Exemplary Method for Accessing an Online Communications System

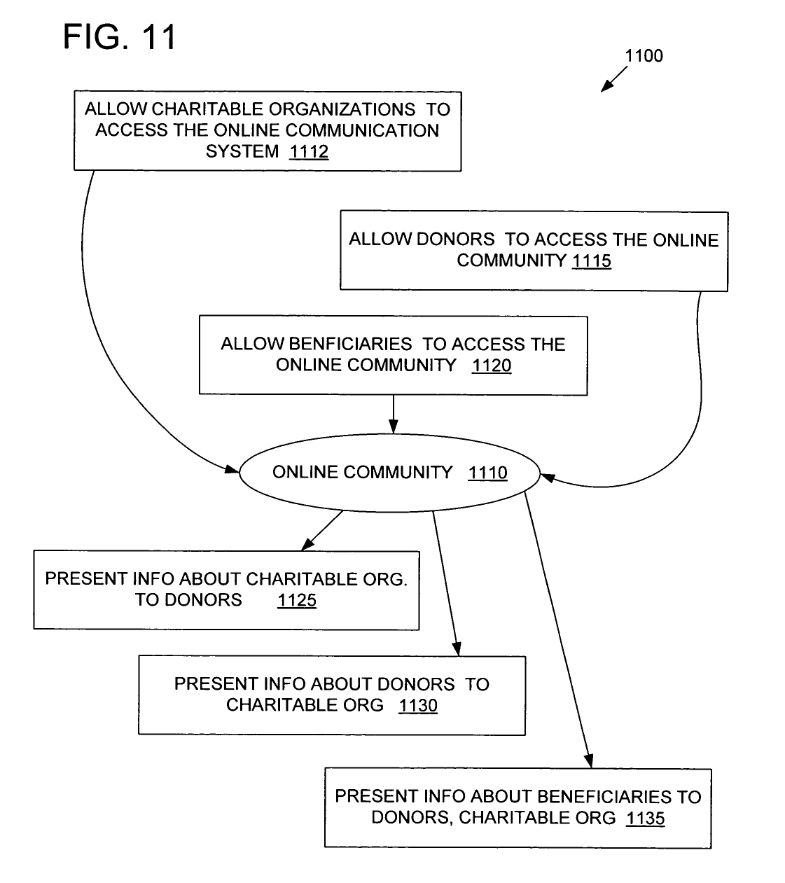

FIG. 11 shows an exemplary method 1100 for accessing an online communication system, such as the online communication system 315 of FIG. 3. The method 1100 can be performed, for example, by the donor management system 165 of FIG. 1B. At process block 1112, charitable organizations are allowed to access an online community 1110, such as people who access the community meeting place 205, 206, 207 (FIG. 2). At process block 1115 donors are allowed to access the online community 1110. At process block 1120 beneficiaries are allowed to access the online community 1110. The online community 1110 may have access to a database 167 (FIG. 1B).

At process block 1125, information about the charitable organizations , such as information stored in the database 167 (FIG. 1B) which may include communications information 616 (FIG. 6) gathered from online communications 315 (FIG. 3), may be presented to donors, such as the donors 155 (FIG. 1B). At process block 1130, information about the donors is presented to charitable organizations. At process block 1135, information about beneficiaries, such as the beneficiaries 226 (FIG. 2) is presented to at least one of donors and/or charitable organizations.

### EXAMPLE 13

### Exemplary Method for Creating and using a Database.

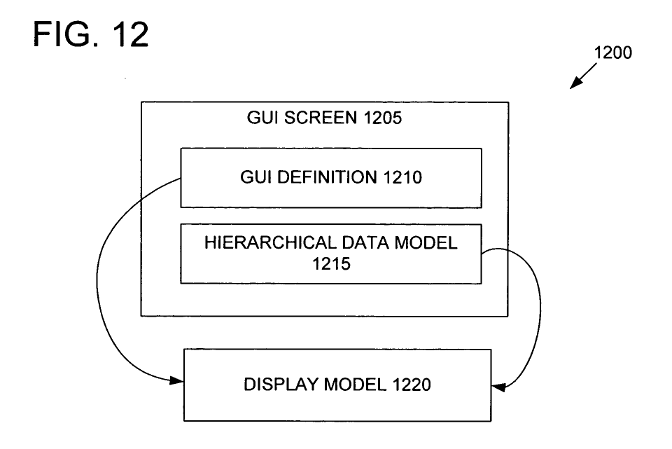

FIG. 12 shows an exemplary database 1200 which can be used in any of the examples herein. A database, such as the database 667 of FIG. 6, can be created. A graphical user interface (GUI) screen 1205 can be developed to define the structure of a database, the GUI screen having a GUI definition 1210. Data entered using the GUI screen can be stored as a data model 1215 with a structure, which may be a hierarchical data model, a relational data model, etc. The GUI definition 1210 can then be stored as a GUI definition 1210 with a similar structure to the data model 1215. When a display model is to be generated, the GUI definition 1210 and the data model 1215 can be combined to generate a display model 1220 which allows entry of data into the database 1200, which may be the database 167 (FIG. 1B) of the donor management system 167 (FIG. 1.) If the data model 1215 is hierarchical, it can comprise a root and named nodes. In an exemplary embodiment, respective named nodes in the hierarchical data entity having unique names. Furthermore, the unique names can comprise relationship paths through the hierarchical data entity.

In another aspect, successive versions of a data model representation of a database can be stored. Each data element within a version has a unique name, while each matching data element across different versions has an identical name. For at least some of the versions of the data model representation, a substantially mirror-image GUI definition 1210 is stored as well. Within this GUI definition 1210, substantially all data elements in the data model 1215 have similarly-named elements in the GUI definition 1210.

A data model creator can be built. This data model creator can create an acyclic and hierarchical data model 1215. The system can also comprise a data namer which ensures that respective data locations within a single instantiation of the data model have unique names and that respective data locations within multiple instantiations of the data model 1215 have semantically equivalent names. The system further may comprise a GUI definition creator which creates a GUI definition 1210 wherein the GUI definition 1210 substantially mirrors the data model 1215. A data model and GUI definition combiner may also be present which combines the data model 1215 and the GUI definition 1210 to create a combined display model 1220.

### EXAMPLE 14

### Exemplary Computing Enivironment

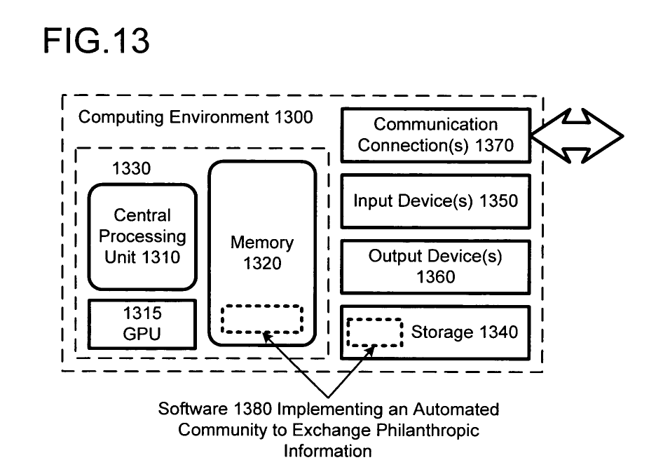

FIG. 13 and the following discussion are intended to provide a brief, general description of an exemplary computing environment in which the disclosed technology may be implemented. For instance, any of the functionalities described with respect to creating or using an automatically modifiable database GUI and structure in FIG. 12 can be implemented in such a computing environment. Although not required, the disclosed technology was described in the general context of computer-executable instructions, such as program modules, being executed by a personal computer (PC). Generally, program modules include routines, programs, objects, components, data structures, etc., that perform particular tasks or implement particular abstract data types.

Moreover, the disclosed technology may be implemented with other computer system configurations, including hand-held devices such as PDAs, multiprocessor systems, microprocessor-based or programmable consumer electronics, personal computers (PCs), portable personal computers, network PCs, minicomputers, mainframe computers, and the like. Any number of suitable operating systems may be used, such as, for example and not limitation, UNIX or one of its many flavors, Linux, one developed by Microsoft for use on PC's, an Apple operating system, an operating system developed specifically for mainframes, such as those developed by IBM, or the like. The disclosed technology may also be practiced in distributed computing environments where tasks are performed by remote processing devices that are linked through a communications network. In a distributed computing environment, program modules may be located in both local and remote memory storage devices.

FIG. 13 illustrates a generalized example of a suitable computing environment 1300 in which described embodiments may be implemented. The computing environment 1300 is not intended to suggest any limitation as to scope of use or functionality of the disclosed embodiments, as the present disclosed embodiments may be implemented in diverse general-purpose or special-purpose computing environments.

With reference to FIG. 13, the computing environment 1300 includes at least one central processing unit 1310 and memory 1320. In FIG. 13, this most basic configuration 1330 is included within a dashed line. The central processing unit 1310 executes computer-executable instructions and may be a real or a virtual processor. The environment 1300 further includes the graphics processing unit GPU at 1315 for executing such computer graphics operations as vertex mapping, pixel processing, rendering, and texture mapping. In a multi-processing system, multiple processing units execute computer-executable instructions to increase processing power and as such the GPU and CPU can be running simultaneously. The memory 1320 may be volatile memory (e.g., registers, cache, RAM), non-volatile memory (e.g., ROM, EEPROM, flash memory, etc.), or some combination of the two. The memory 1320 stores software 1380 implementing the described methods of creating, using, or facilitating the use of an automated community.

A computing environment may have additional features. For example, the computing environment 1300 includes storage 1340, one or more input devices 1350, one or more output devices 1360, and one or more communication connections 1370. An interconnection mechanism (not shown) such as a bus, controller, or network interconnects the components of the computing environment 1300. Typically, operating system software (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store information and which can be accessed within the computing environment 1300. The storage 1340 stores instructions for the software 1380 to implement methods of creating, using, or facilitating the use of an automated community.

The input device(s) 1350 may be a touch input device such as a keyboard, mouse, pen, or trackball, a voice input device, a scanning device, touchscreen, or another device that provides input to the computing environment 1300. For audio, the input device(s) 1350 may be a sound card or similar device that accepts audio input in analog or digital form, or a CD-ROM reader that provides audio samples to the computing environment. The output device(s) 1360 may be a display, printer, speaker, CD-writer, or another device that provides output from the computing environment 1300.

The communication connection(s) 1370 enable communication over a communication medium to another computing entity. The communication medium conveys information such as computer-executable instructions, compressed graphics information, or other data in a modulated data signal. These connections may include network connections, which may be wireless connections, may include dial-up connections, and so on. The other computing entity may be a portable communications device such as a wireless handheld device, a cell phone device, and so on.

Computer-readable media are any available tangible media that can be accessed within a computing environment. By way of example, and not limitation, with the computing environment 1300, computer-readable media include memory 1320, storage 1340, communication media, a carrier wave through with the media can be transmitted across a network such as the internet, and combinations of any of the above.

Moreover, any of the methods, apparatus, and systems described herein can be used in conjunction with creating, using, or facilitating the use of an automated community in a wide variety of contexts.

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine” and “identify” to describe the disclosed technology. These terms are high-level abstractions of the actual operations that are performed. The actual operations that correspond to these terms will vary depending on the particular implementation and are readily discernible by one of ordinary skill in the art.

Further, data produced from any of the disclosed methods can be created, updated, or stored on tangible computer-readable media (e.g., tangible computer-readable media, such as one or more CDs, volatile memory components (such as DRAM or SRAM), or nonvolatile memory components (such as hard drives)) using a variety of different data structures or formats. Such data can be created or updated at a local computer or over a network (e.g., by a server computer).

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method of providing a philanthropic community communication system comprising in combination:
A. providing an online philanthropic community communication system; and
B. with the online philanthropic community communication system, allowing a first plurality of online users to conduct first topic on-line communication among each other and allowing one or more additional online users to have access to said first topic on-line communication and to participate in said first topic on-line communication; and
C. with the online philanthropic community communication system, allowing the first plurality of online users or another plurality of online users to conduct a second topic on-line communication among each other and allowing said one or more additional online users to have access to said second topic on-line communication and to participate in said second topic on-line communication.

2. The method of claim 1 wherein the online communication comprises at least one of chatting, blogging, podcasting, or engaging in an online bulletin board discussion.

3. The method of claim 1, wherein the at least one on-line user is selected from the group consisting of a donor, a potential donor, a beneficiary, a potential beneficiary, a business, a charitable organization, and an advertiser.

4. A method of providing a philanthropic community communication system in conjunction with a philanthropic project information system, comprising in combination:
A. providing an online philanthropic project information system comprising posting information regarding philanthropic projects;
B. with the online philanthropic project information system, providing online users access to said philanthropic information system and review of said information regarding philanthropic projects;
C. providing an online philanthropic community communication system in conjunction with the philanthropic project information system; and
D. with the online philanthropic community communication system, allowing a first plurality of online users to conduct on-line communication among each other and allowing one or more additional online users to have access to said on-line communication and to participate in said on-line communication.

5. The method of claim 4 wherein the online communication comprises at least one of chatting, blogging, engaging in an online bulletin board discussion, or podcasting.

6. The method of claim 4, wherein at least one on-line user comprises a donor, a potential donor, a beneficiary, a potential beneficiary, a charitable organization, or an advertiser.

7. The method of claim 4, further comprising providing the online capacity to restrict access to at least a portion of the information regarding philanthropic projects.

8. The method of claim 4, further comprising providing the online capacity requiring user registration prior to allowing a user access to the online philanthropic community communication system.

9. The method of claim 8, wherein providing the online capacity requiring user registration further comprises providing the online capacity to allow the user to select an anonymous user name.

10. The method of claim 4, further comprising providing the ability for a designated entity to moderate at least a portion of the online communication by other parties.

11. The method of claim 4, further comprising at least one of the following through the online communication system: providing the ability to create a blog as a component of the philanthropic online communication system, providing the ability to access the blog, providing the ability to add an entry to the blog, providing the ability to delete an entry from the blog; providing the ability to define at least one community goal; providing the ability to receive a chat message in a chat room associated with the online communication system, or providing the ability to send a chat message to another user in the chat room.

12. The method of claim 11, further comprising providing access to a shared calendar associated with the online philanthropic project information system.

13. A computer-readable medium having computer executable instructions for performing the method of claim 4.

14. A computer-implemented system for sharing philanthropic information comprising a donor management system, and an online community meeting place integrated into the donor management system, the online community meeting place comprising at least one of a chat room, a blog, or an online message board, whereby members of an online community can exchange information about a philanthropic cause using the online community meeting place.

15. The computer-implemented system of claim 14, wherein the chat room further comprises at least one private chat room.

16. The computer-implemented system of claim 14, wherein the online community meeting place comprises a shared calendar

17. The computer-implemented system of claim 14, wherein the online community meeting place comprises a community goal.

18. The computer-implemented system of claim 14, wherein an online community meeting place comprises a user interface, the user interface being adjustable by at least one member of an online community associated with the online meeting place.

19. The system of claim 18, further comprising a database, the database comprising at least one of: user information about at least one member of the online community, or project information about at least one charitable project associated with the online community.

20. The system of claim 19, further comprising an advertiser-member associator feature, whereby the advertiser-member associator feature associates at least one member of the online community with an advertisement based upon database information in the database.
